(19) United States
(12) Patent Application Publication
(10) Pub. No.: US 2010/0211435 A1
(43) Pub. Date: Aug. 19, 2010

(54) Package Review Process Mentorship System

(75) Inventors: Maureen Emily Duffy, Westford, MA (US); Evangeline A. McGlynn, Somerville, MA (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(73) Assignee: Red Hat, Inc., Raleigh, NC (US)

(21) Appl. No.: 12/372,629

(22) Filed: Feb. 17, 2009

(51) Int. Cl. G06Q 10/00; G06Q 50/00

(52) U.S. Cl. 705/10; 705/7; 705/14.19

(57) ABSTRACT

A method and apparatus for an automated software package review process mentorship system. The package review system receives proposed package from programmers to be reviewed before inclusion in a software project or collection. This system can also be used for the review and analysis of other types of projects. The system includes a package management module that works in conjunction with a review management module to automatically assign the received packages to reviewers that have the appropriate skills and availability to review the type of packages that have been submitted. If the reviewer does not complete the review within a specified time period, then the package can be automatically reassigned. In addition, the package reviewer is given an interface for providing feedback to the package submitter that simplifies the task of the reviewer by providing a set of predefined responses.

### TECHNICAL FIELD

Embodiments of the present invention relate to a method and system for managing package review. Specifically, embodiments of the present invention relate to a method and system for determining a mentor or reviewer for submitted packages or other type of software content and monitoring the progress of that review process.

### BACKGROUND

Most large projects are broken up into sub-components or a set of inter-related components that have different employees or volunteers working on them to implement the respective aspects of the overall project. These employees and volunteers have various skill levels and reliability levels. Thus, their work may need to be reviewed before it is incorporated into the whole of the project or otherwise relied upon by others. One example of this review process is the submission and review of packages in an open source software programming environment. In this environment, someone must be tasked with the responsibility of reviewing and ensuring that each package that has been submitted for inclusion into the project is of sufficient quality, compatible with other project components, performs the intended task, and does not contain significant errors.

However, finding individuals who have the time, the interest, and the skill to review, approve and give feedback for each of the submitted packages in the project can be time- and resource-intensive and can significantly delay the review of a specific component that has been submitted as well as the overall project.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a package review process mentorship system.

FIG. 2 is a diagram of one embodiment of a user interface for the package review process mentorship system.

FIG. 3 is a diagram of another embodiment of the user interface of the package review process mentorship system.

FIG. 3 is flowchart of one embodiment of a process for assigning packages to a reviewer.

### DETAILED DESCRIPTION

Described herein is a method and apparatus for an automated package review process mentorship system. The package review system receives package submissions from programmers to be reviewed before inclusion in a software project. This system can also be used for the review and analysis of other types of projects and content. The system includes a package management module that works in conjunction with a review management module to assign the received packages to reviewers that have the appropriate skills and availability to review the type of packages that have been submitted. If the reviewer does not complete the review within a specified time period, then the package can be automatically reassigned to another reviewer. In addition, the package reviewer is given an interface for providing feedback to the package submitter that simplifies the reviewer's task by providing a set of predefined responses while viewing the submitted content. The package review system also provides an interface to view feedback by other reviewers of the software package to assist the tasked reviewer in the reviewing and approval process. In addition, the package review system provides an interface to view historical information about the past submissions to the system by a submitter of a package, including other feedback of other reviewers about their submissions and how successful the previous package submissions of the submitter may or may not have been.

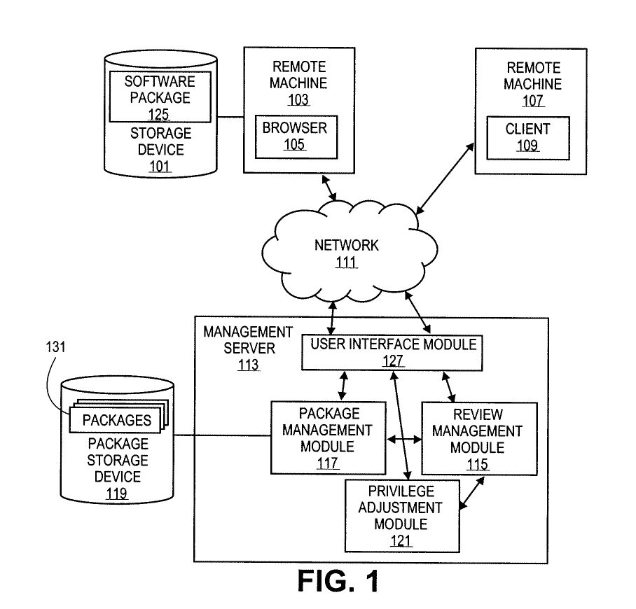

FIG. 1 is a diagram of one embodiment of the package review process mentorship system. The package review process mentorship system includes a management server 113 and package storage device 119. The management server 113 can communicate with a set of remote machines 103, 107 over a network 111. A ‘set,’ as used herein can refer to any positive whole number of items including one item. The network 111 can be any type of network including a local area network (LAN), a wide area network (WAN) such as the Internet or similar networks. The network 111 can include any number of elements including both wired and wireless networking components. Any number of remote machines 103, 107 can be connected to the management server 113. In another embodiment the management server 113 can be a distributed system that is implemented over multiple server machines.

The management server 113 can be a computing device such as a desktop computer, laptop computer, dedicated server, console device, networking device or similar computing device. The management server includes a package management component 117, a review management module 115, a privilege adjustment module 121 and a user interface module 127. The management server 113 is also in communication with or incorporates a package storage device 119. The embodiments of the management server 113 described herein relate to and implement a package review process. However, one of ordinary skill in the art would understand that the principles and structures described herein are also applicable to the management and review of sub-components of or content for other types of large projects. The package management review process is described for the sake of clarity and conciseness in describing the underlying principles of the invention.

The user interface module 127 can provide a graphical user interface, command line interface or similar interface for accessing the functionality of the other modules including the package management module 117, review management module 115 and privilege adjustment module 121. In one embodiment, the user interface module 127 is a web-server that can provide access to the management server 113 functionality to any number of browsers 105 on remote machines 103. In another embodiment, the user interface module 127 provides access to the management server 113 functionality to application specific clients 109 on remote machines 107. The user interface module 127 receives package submissions and queries on the package review process and present the users of the remote machines 103, 107 with the user interface features and functionality described herein.

The package management module 117 receives a package submission over the network 111 from the set of remote machines 103, 107. The package management module 117 interfaces with the user interface module 127 to provide functionality to the remote machines 103, 107 by providing an interface to facilitate the uploading of the software packages. In another embodiment, the remote machines 103, 107 directly interact with the package management module 117 through an integrated interface. In a further embodiment, a specialized client server relationship is established by the package management module 117 with a specialized package submission application on the remote machines 103, 107.

The package management module 117 receives a package submission through the user interface module 127 and stores the package submission in the package storage device 119 that is local the management server 113 as a set of package files 131 in a file system. In another embodiment, the packages 131 are stored in a database or similar storage structure. In another embodiment, the package storage device 119 is remote from the management server 113. The package management module 117 then notifies the review management module 115 of the received submission. The package management module 117 can also record meta data related to the submitted packages such as time of submission, the remote machine address that provided the submission, the user that provided the submission, the computer language that the package is written in, subject matter and related skill information that is provided by the user making the submission and similar data. The skill and subject matter data can be referred to as a set of tags or descriptors that are tied to the package submission.

The review management module 115 receives notification of received packages for review from the package management module 117. The review management module 115 is then tasked with the assignment of the review of the package to a specific user or set of users that are referred to as reviews or mentors. The review management module 115 can implement any algorithm or process for assigning the package to a mentor for purposes of completing a review process. One embodiment of this process is described herein below in regard to FIG. 4.

The review management module 115 can interact with or leverage a database of user profiles or similar user information as well as the meta data in the form of tags, descriptors and other data tied to the package submissions. The review management module 115 identifies the skills or experience that is required to review each submitted package by analysis of the metadata. The required skills and experience are then used to search through a user profile database or similar user information to find users that possess the required skills and experience.

The review management module 115 can also track the progress of the review process and feedback from the reviewers during the review process. The review management module 115 can also provide reminders to the mentor assigned to a package submission to complete the reviewing assignment. If a mentor of a submitted package does not complete the review process during a pre-defined time period, then the review management module 115 reassigns the review process for the submitted package to another user. The review management module 115 report feedback information such as package approvals and package denials and related feedback to the privilege adjustment module 121.

A privilege adjustment module 121 receives information from the review management module 115 relating to the success, failure or similar feedback information related to a submitted package. The privilege adjustment module 121 tracks the success rate, feedback and similar information for each package and each package submitter that utilizes the management server 113. This information is utilized to adjust the privileges tied to the user accounts of the package submitters. For example, when a submitter successfully submits and gains package review approval for a pre-defined number of packages, the privileges tied to their account will be increased or modified such that subsequent submissions by that submitter's user account will require less review or no review at all. This would allow the packages submitted through that user's account to be automatically approved and incorporated into the overall project or other components of the software package. The thresholds for privilege adjustment can be set by an administrator of the management server 113 or can be pre-defined by any programmer or similar entity. The criteria that are tracked for privilege adjustment can include approval rate, number of approved packages, feedback related statistics and similar criteria that can be used to infer the level of competence of the individual using the user account.

These components of the management server 113 can interact with other components of the overall project management system that provide access to user profile information, project builds or subsets of those builds and similar project management components. These project management components can be on the management server 113 or on a separate server or distributed over multiple servers.

The package storage device 119 can be any type of persistent storage device including fixed-disc devices such as magnetic storage devices, optical storage devices and similar storage devices. The package storage device 119 can be an array of such storage devices or distributed over multiple storage devices. A package storage device 119 can also encompass a database management system that manages the retrieval and storage of the packages 131 as they are requested or accessed by the package management module 117. In another embodiment, the package storage device 119 can be managed by other types of data storage systems such as file system managers.

Remote machines 103, 107 can be any type of computing devices including desktop computers, laptop computers, handheld computers, dedicated servers, work stations, household devices and similar computing devices. The remote machines 103, 107 can provide a browser application 105, dedicated client application 109 or similar application that enables the user of the remote machine 103, 107 to interface with the management server 113 and package management module 117. The remote machine 103 can include or be in communication with a local storage device 101 for storing a software package 125. A software package 125 can be a project or component of a project that the user of the remote machine 103 has developed. The software package 125 is stored in the storage device 101 which can be any type of storage device including magnetic storage device, an optical storage device, a solid-state storage device or similar storage device that is local or remote from the remote machine 103.

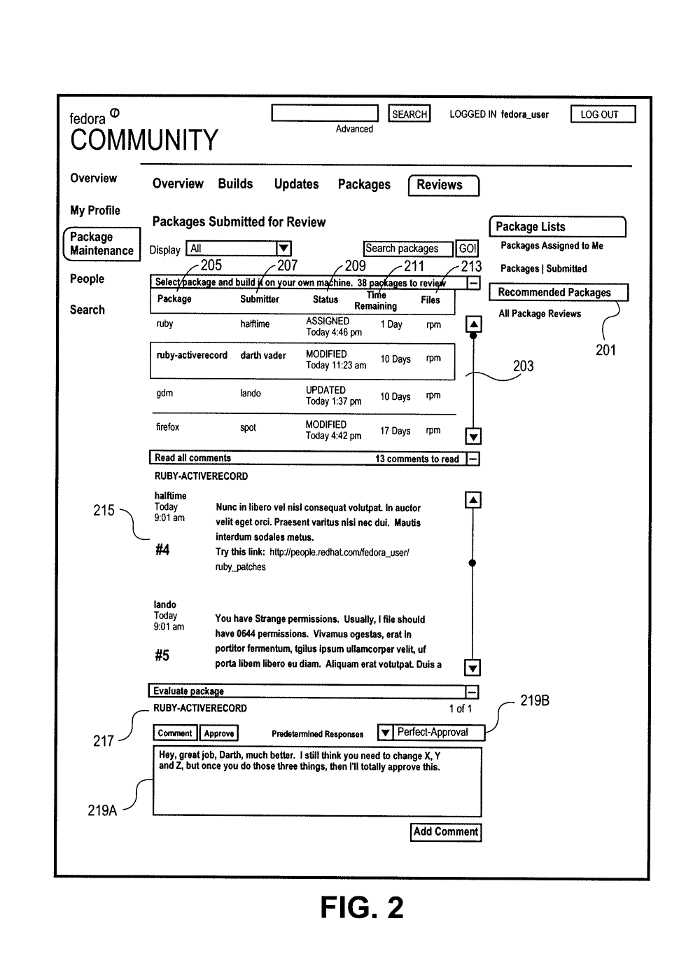

FIG. 2 is a diagram of one embodiment of the graphical user interface for the package review process mentorship system. The graphical user interface provides a set of tools to a mentor to assist and manage the process of reviewing incoming package submissions. The graphical user interface includes a package view menu 201, a package selection or package recommendation menu 203, a community comment section 215 and a reviewer input section 217. These components of the graphical user interface system can be arranged in any order and can be presented in separate pages or through any combination of different pages. In another embodiment, the graphical user interface may provide a preview, full view, or if appropriate to the content type being reviewed, a download link for the content to be reviewed alongside the controls used to provide feedback on the content.

The package review menu 201 allows the mentor to view the packages in the review process system through different filters and user interface mechanisms. The menu options can include a menu item to show packages assigned to the viewer, a set of packages submitted by the viewer, a set of recommended packages to be reviewed or that have been assigned for review to the viewer, a list of all packages in the system or all reviews in the system. Any number of additional views of the available packages and package submission review assignments can be included in the menu 201 to allow a viewer or other users of the system to track the status and identify packages in the review process. Even individuals that have not been assigned to review a specific project can be allowed to use this interface or similar interface to identify packages they would like to review and make comment on. The user who submits a package can also utilize the interface to determine the current status and feedback on his package and to manage the process of the package within the system.

The package recommendation window 203 includes a list of packages that the system has identified as being relevant to the current viewer of the graphical user interface. The packages may be specifically assigned to the viewer to be reviewed solely where the viewer is a mentor or within a group of other reviewers. Where the viewer is a mentor, the packages may consist of those packages that were entered into the system by submitters assigned to that particular mentor. The set of displayed packages can also include packages that are recommended to the viewer based on his/her interests or past reviewing process behavior. In one embodiment, the recommendation window 203 includes a listing of packages based on the package name 205, the submitter of the package 207, a current status of the package 209, a time remaining status 211 and the content link 213. In another embodiment, another filter can be applied to the window such that any set of the available packages are displayed based on parameters or criteria specified by a user.

The package name column 205 reflects the name of the package as specified by the submitter of that package. The package submitter column 207 identifies the user who entered the package into the review process system. The username of the submitter may be used to navigate to their submission history in order for the reviewer to assess the skill and background of the submitter as part of the review process. The status column 209 reflects the status indicated by the review management module or otherwise entered by a reviewer or mentor of the specific package. The status information can include the timing of the assignment of the package, the modification time of the package, or other events related to the package. The time remaining column 211 indicates the amount of time remaining for an assigned mentor who has not begun or continuously engaged in the review process to complete the review process. At the expiration of this time period, the package can be reassigned to another mentor for review or can be similarly reassigned. The file description column 213 provides basic information about the type, size and similar characteristics of the files that are associated with the package. A link to the location of files or resources can be presented in this field.

The community comment section 215 includes a display of the feedback entered into the system by each of the users that have reviewed the software package. The information and feedback can be ordered based on the time of entry, the user who generated the entries, or based on viewer specified criteria. The feedback information in this section reflects any review information input by users in the community including mentors and others who were not specifically tasked with reviewing a particular package.

The evaluation menu 217 provides an interface for the viewer of the graphical user interface to provide comments and to provide a definitive review of the currently selected software package. An evaluation menu provides a set of pre-defined responses in a convenient user interface mechanism such as a drop down menu 219B or an open-ended text field 219A that allows the viewer to provide any additional or specific information about the currently selected package. The viewer can then add these comments to the record, which can be viewed above in community comment section. If the viewer is an assigned mentor for the package the selected comments and feedback can include a definitive approval or refusal declaration that indicates whether the submitted package meets the relevant criteria to be approved for inclusion in the overall project or other components of the project. Input feedback can be automatically sent via e-mail or similar messaging to the submitter or the feedback data can be stored for display in a community comment section 215.

Other windows that may be presented through the graphical user interface can include a current privilege status window, a privilege feedback information window where a user can determine what his current status is in the process of achieving higher levels of privilege based on success in the review process or similar types windows. Other menus can include a build window or similar interface for viewing or downloading files and components of a software package or set of software packages to a local machine so that they can be tested and analyzed by the reviewer, and a submitter history window to view details about the other submitted packages from the submitter, reviews received, and other information about their past interactions in the system. Any number of windows or window sections that are necessary for displaying each of these features can be include in the graphical user interface.

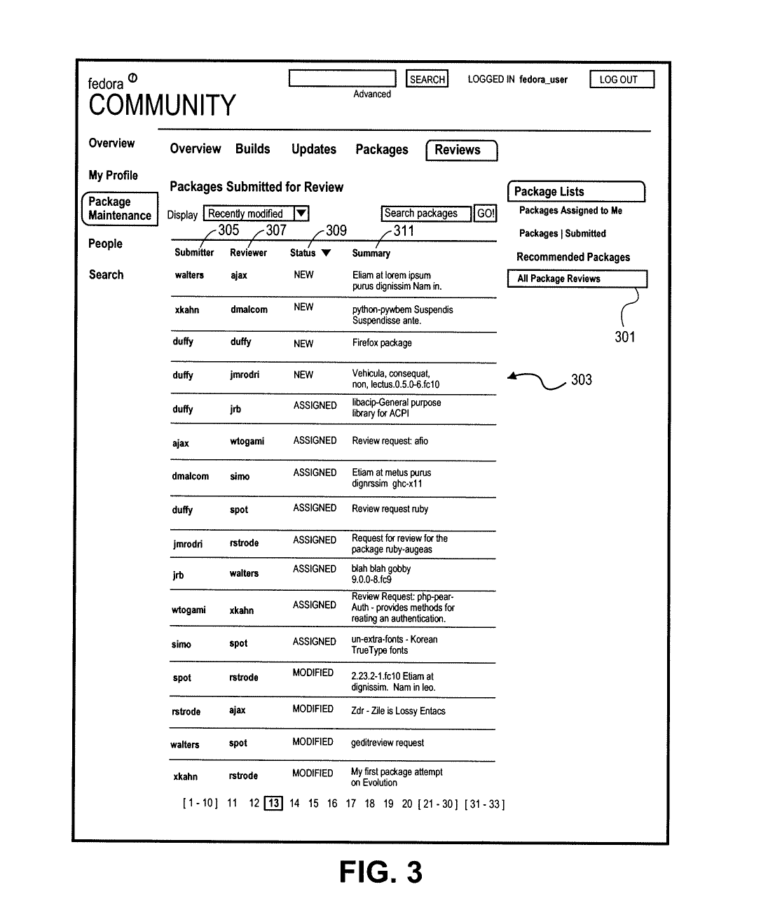

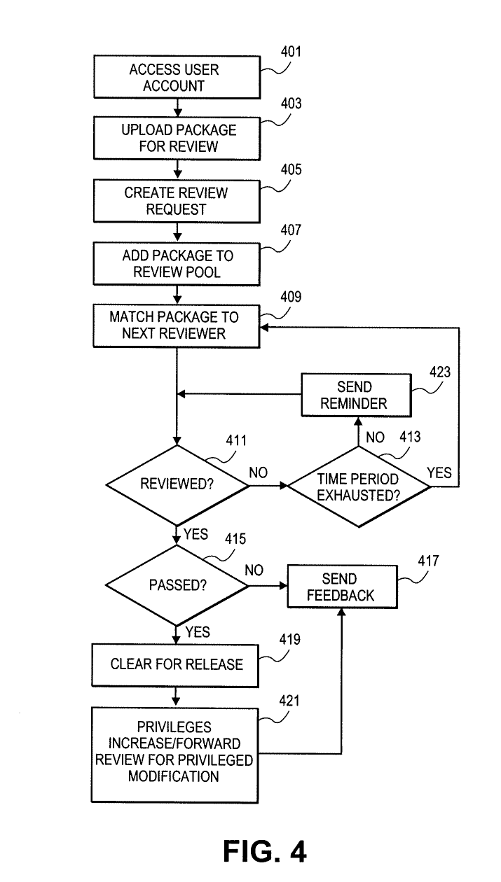

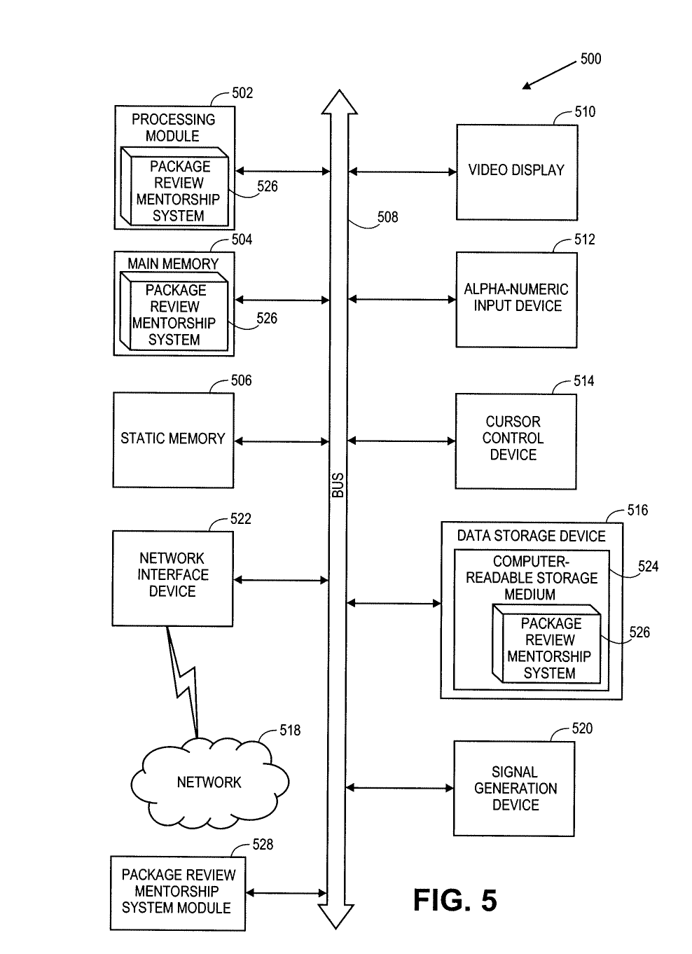

FIG. 3 is a diagram of one embodiment of another view of the available packages. In this view, a recommended package review selection has been made in a package viewing menu 301. The package viewing menu 301 specifies a set of possible viewing filter criteria. In the selected view all of the packages in the system are displayed that meet the recommended package criteria that can be fit on the specific page. Any number of entries can be shown in a listing 303 on a single page or a parameter can be set to restrict the number of simultaneously displayed entries.

Information for each entry can include the submitter 305, the assigned reviewer or mentor for the package 307, the current status information 309, summary information 311 and similar data. This data is analogous to the data that is displayed in the recommendation window described above in regard to FIG. 2. The values of these fields of each entry can be continuously updated or periodically updated by the actions of the mentor or through the overall review process.

FIG. 4 is a flowchart of one embodiment of a process for package assignment and review management. In one embodiment, the process is initiated by a user accessing an account on the review process system provided by management server (Block 401). The user can log into or access the user account remotely (e.g., from a remote machine over a network) or locally to the management server. A graphical user interface can be provided by the management server as described above or a similar interface to display any current status on previously submitted packages and for the step of uploading a software package to be reviewed (Block 403).

Once the software package has been specifically uploaded the system automatically creates a review request (Block 405). The generation of a review request indicates that the necessary files of a package submission have been successfully uploaded into the management server and package storage device and can be made available to any potential reviewer. The package management module initiates the review management module and its matching algorithm by sending the review request, which includes information about the appropriate reviewer based on the metadata specified by the submitter or collected during the upload and stored as metadata with the package and the reviewer.

The submitted package is then added to a review pool while it awaits the outcome of a matching process (Block 407). Once the review request is processed and package added to the review pool, a specific user is selected to be the mentor for the package by the review management module or similar module. The review management module executes a matching algorithm to match the package to the next reviewer or mentor (Block 409). The submitted package can be forwarded to the reviewer or mentor or a link or similar identifier sent to the reviewer or mentor. The submitted package can be tagged with specific attributes that are stored in the metadata that can be utilized to match the submitted package to a specific pre-order. Tags for submitted software components can include programming language information, file size information, file history information, deadline information and similar information and criteria.

After the package has been successfully matched with a reviewer or mentor having the requisite skills or the nearest approximation of those skills, a check is periodically made to determine whether the mentor has completed his work (Block 411). If the mentor has not completed his work, then a check is made to see if the review period that has been allotted for a given package has expired. If the time period for completing a review has completed, the process continues by selecting the next match (Block 409). If the time period for completing the review has not expired then the review management module 115 can send a reminder notification that the package is ready and that the reviewer has a limited time period to complete the review (Block 423).

The pool of reviewers or mentors to which a package can be assigned can been exhausted and an error can be generated. If the pool of available reviewers has been exhausted then the process goes back to the review management module and the filter criteria for identifying potential reviewers or mentors is altered.

Once the review data has been input, a check is made to determine whether the mentor has indicated that the software package has successfully passed (Block 415). If the tests have been passed then the submitted software package may be cleared for release (Block 419). In the next step, information relating a successful package approval is forwarded to the privilege adjustment module. A successful completion of a package for a submitter can be responded to by updating tracking information or privilege information for that submitter to give that submitter credit for having completed the package (Block 421). The credits and tracking information can be periodically or responsively calculated and used to check privileges against a set of thresholds that determine the privileges for each user account in the system.

If, however, the mentor of a package submitter declines to approve the package submitted for review, then the package failure information and the feedback input by the mentor is sent to the submitter so the submitter can then update and correct the software package and resubmit it (Block 417). Not only is the mentors feedback entered and stored into the system, but any other community feedback can be associated with the package and a message sent to the user who submitted the package to notify him that the feedback information is available through the graphical interface.

FIG. 5 is a diagram of one embodiment of a computer system for providing a package review process mentorship system. Within the computer system 500 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine (e.g., a client computer executing a browser and the server computer executing the package review process mentorship system) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a secondary memory 516 (e.g., a data storage device in the form of a drive unit, which may include fixed or removable computer-readable medium), which communicate with each other via a bus 508.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, processing device implementing other instruction sets, or processing devices implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute the package review process mentorship system 526 for performing the operations and steps discussed herein.

The computer system 500 may further include a network interface device 522. The computer system 500 also may include a video display unit 510 (e.g., a liquid crystal display (LCD) or a cathode ray tube (CRT)) connected to the computer system through a graphics port and graphics chipset, an alphanumeric input device 512 (e.g., a keyboard), a cursor control device 514 (e.g., a mouse), and a signal generation device 520 (e.g., a speaker).

The secondary memory 516 may include a computer-readable storage medium 524 on which is stored one or more sets of instructions (e.g., a package review process mentorship system 526) embodying any one or more of the methodologies or functions described herein. The package review process mentorship system 526 may also reside, completely or at least partially, within the main memory 504 and/or within the processing device 502 during execution thereof by the computer system 500, the main memory 504 and the processing device 502 also constituting computer-readable storage media. The package review process mentorship system 526 may further be transmitted or received over a network 518 via the network interface device 522.

The computer-readable storage medium 524 may also be used to store the package review process mentorship system 526 persistently. While the computer-readable storage medium 526 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the computer and that cause the computer to perform any one or more of the methodologies of the present invention. The terms computer-readable storage medium” shall accordingly be taken to include, but not be limited to, solid-state memories, and optical and magnetic media.

The modules 528, components and other features described herein (for example in relation to FIG. 1) can be implemented as discrete hardware components or integrated in the functionality of hardware components such as ASICS, FPGAs, DSPs or similar devices. In addition, the modules 528 can be implemented as firmware or functional circuitry within hardware devices. Further, the modules 528 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention. It should be noted that different references to “an” or “one” embodiment in this disclosure are not necessarily to the same embodiment, and such references mean at least one.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “matching,” “reassigning,” “sending,” “adding,” “providing,” “comparing,” “forwarding,” “increasing,” or the like, refer to the actions and processes of a computer system, or similar electronic computing device that manipulates and transforms data represented as physical (electronic) quantities within the computer system's registers and memories into other data similarly represented as physical quantities within the computer system memories, registers or other such information storage, transmission or display devices.

The present invention also relates to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, Flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A computer readable medium includes any mechanism for storing information in a form readable by a computer. For example, a computer readable medium includes read only memory (“ROM”), random access memory (“RAM”), magnetic disk storage media; optical storage media, flash memory devices or other type of machine-accessible storage media.

Thus, a method and apparatus for package review process mentorship system has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A computer-implemented method comprising:
receiving software packages for review through a package management module;
matching the package with a reviewer automatically based on a software package descriptor and a user profile by a review management module; and
automatically reassigning the software package to a next reviewer, if not reviewed within a pre-defined time period by the review management module.

2. The computer-implemented method of claim 1, further comprising:
sending a reminder automatically to the reviewer to complete the review within the pre-defined time period.

3. The computer-implemented method of claim 1, further comprising:
adding the package to a pool of software packages to be reviewed.

4. The computer-implemented method of claim 1, further comprising:
providing a reviewer a feedback mechanism to allow selection of pre-defined review responses.

5. The computer-implemented method of claim 1, further comprising:
providing a review mechanism to display profile and historical information about a submitter and past submissions and interactions of the submitter.

6. The computer-implemented method of claim 3, further comprising:
comparing package tags with reviewer skills.

7. The computer-implemented method of claim 4, further comprising:
sending package feedback to the user automatically upon completion of each review.

8. The computer-implemented method of claim 1, further comprising:
forwarding the package to the reviewer.

9. The computer-implemented method of claim 1, further comprising:
increasing user privileges in response to an approval of the package.

10. The computer-implemented method of claim 4, further comprising:
sending reviewer feedback to a submitter of the package.

11. A system comprising:
a package management module to receive and store software packages for review; and
a review management module coupled to the package management module to assign the package to a reviewer automatically based on a user profile and package characteristics.

12. The system of claim 10, further comprising:
a privilege adjustment module coupled to the review management module, the privilege adjustment module to automatically adjust a user privilege in response to a successful review of the package.

13. The system of claim 10, wherein the review management module automatically reassigns the package if not reviewed in a predefined time period.

14. A computer readable storage medium including instructions that, when executed by a computer system, cause the computer system to perform a set of operations comprising:
receiving packages for review through a package management module;
matching the package with a reviewer automatically based on a software package descriptor and a user profile by a review management module; and
automatically reassigning the package to a next reviewer, if not reviewed within a pre-defined time period by the review management module.

15. The computer-readable storage medium of claim 14, having further instructions thereon, which when executed cause the computer system to perform a set of operations, further comprising:
sending a reminder automatically to the review to complete the review within the predefined time period.

16. The computer-readable storage medium of claim 14, having further instructions thereon, which when executed cause the computer system to perform a set of operations, further comprising:
adding the package to a pool of packages to be reviewed.

17. The computer-readable storage medium of claim 14, having further instructions thereon, which when executed cause the computer system to perform a set of operations, further comprising:
providing a reviewer a feedback mechanism to allow selection of pre-defined review responses.

18. The computer-readable storage medium of claim 16, having further instructions thereon, which when executed cause the computer system to perform a set of operations, further comprising:
comparing package tags with reviewer skills.

19. The computer-readable storage medium of claim 17, having further instructions thereon, which when executed cause the computer system to perform a set of operations, further comprising:
sending package feedback to the user automatically upon completion of each review.

20. The computer-readable storage medium of claim 14, having further instructions thereon, which when executed cause the computer system to perform a set of operations, further comprising:
forwarding the package to the reviewer.

21. The computer-readable storage medium of claim 14, having further instructions thereon, which when executed cause the computer system to perform a set of operations, further comprising:
increasing user privileges in response to an approval of the package.

22. The computer-readable storage medium of claim 16, having further instructions thereon, which when executed cause the computer system to perform a set of operations, further comprising:
sending reviewer feedback to a submitter of the package.
